(19) United States
(12) Patent Application Publication
(10) Pub. No.: US 2006/0199690 A1
(43) Pub. Date: Sep. 7, 2006

(54) Chain guide

(75) Inventors: James Gardner, New Fairfield, CT (US); Dale Krantz, Danbury, CT (US)

Correspondence Address: ST. ONGE STEWARD JOHNSTON & REENS, LLC, 986 BEDFORD STREET, STAMFORD, CT, 06905-5619, US

(73) Assignee: Cannondale Bicycle Corporation

(21) Appl. No.: 11/349,315

(22) Filed: Feb. 7, 2006

Related U.S. Application Data
(60) Provisional application No. 60/651,427, filed on Feb. 9, 2005.

(51) Int. Cl. B62J 13/00; F16H 57/02

(52) U.S. Cl. 474/144

(57) ABSTRACT

A bicycle chain guiding device that substantially encloses a front chain wheel inside an interior cavity at least partially defined by a first and a second wall, the second wall provided with entry and exit openings to allow the chain to enter and exit the interior cavity. The entry and exit openings may further be provided with tapered end to allow for entry and exit of the chain at multiple angles.

### CROSS-REFERENCE TO RELATED APPLICATIONS

This application claims the benefit of the filing date of U.S. Provisional Application Ser. No. 60/651,427 filed Feb. 9, 2005.

### FIELD OF THE INVENTION

The invention relates to a guide device for guiding a bicycle chain, and more specifically to an enclosed guiding device for substantially surrounding the chain while on the chain wheel.

### BACKGROUND OF THE INVENTION

Chain driven bicycles typically include a front chain wheel around, which a chain engages with teeth. The application of a rotational force causes the front chain wheel to rotate thereby drawing the chain around the front chain wheel. Typically, the chain is also attached to a rear chain wheel that is coupled to the rear wheel of the bicycle, allowing for a driving action. If the chain becomes disconnected from or cross-threaded on the front chain wheel, the cyclist will most often have to stop and fix the disconnected or tangled chain. Not only is this inconvenient, but in some instances, damage to the chain and the mechanism may occur. Especially in competition, any delay or slow downs must be avoided. Likewise, it is highly desirable to avoid damage to relatively expensive equipment.

Damage and dislocation of the chain from the front chain wheel is especially likely in off-road cycling applications where riders are often putting great stress on the bicycle dropping down relatively steep slopes and performing trick jumps. In these situations, avoidance of any type of mechanical failure is desired to avoid injury to the cyclist.

While the cyclist typically engages the bicycle with their feet on the pedals, increasingly trick and off-road cyclists are standing on various parts of the bicycle to perform stunts. As the cyclist is bringing their feet up off of or down onto the pedals, contact with the chain, for example, on the top of the front chain wheel, by the cyclists shoes/boots should be avoided to minimize damage to the mechanism.

It should also be noted that, with competitive bicycle racing, any added weight to the bicycle should be minimized as even a relatively small increase in weight of the bicycle can slow the cyclist down.

What is desired then is a device that will substantially maintain the chain in an engaged position on the front chain wheel, even in extreme riding conditions.

It is further desired to provide a device and method for protecting the chain and the drive mechanism from damage during extreme riding conditions.

It is still further desired to provide a device and method for protecting a chain and drive mechanism that does not substantially increase the overall weight of the bicycle, yet still provide robust protection.

### SUMMARY OF THE INVENTION

These and other objects are achieved by the provision of a chain guiding device that may be mounted on, for example, the front chain wheel of a chain driven bicycle.

The chain guiding device may in one embodiment, substantially surround the chain on the front chain wheel so that the chain has substantially no room for movement off of the front chain wheel. The device may be formed as a disk having a peripheral end wall, being substantially circular in cross-section and having an entry opening in the peripheral end wall provided to allow entry of the chain into the chain guiding device and another opening in the peripheral end wall to allow exiting of the chain from the chain guiding device.

Additionally, the entry and exit openings may be provided as relatively large angle openings such that large differentials in the chain angle for entry and exit may be accommodated as desired.

In one advantageous embodiment, the interior cavity of the chain guiding device is advantageously kept relatively small (i.e. in relatively close tolerance with the chain and front chain wheel), such that play of the chain is minimized. In another embodiment, the chain guide may be provided with bolt-hole openings for receiving bolts therein for mounting of the device directly to the bicycle. The chain guide is further provided with a relatively large center opening for receipt of the pedal shaft, which extends therethrough.

In another advantageous embodiment, the chain guide is provided with a notch located therein such that the device may accommodate the lower frame members of the bicycle frame extending rearward from the down tube.

The chain guide may further be used in conjunction with a “bash guard” that mounts to the cranks. The bash guard is used to substantially prevent the chain from falling to the outside of the bicycle, while the chain guide may be used to maintain the chain at all points when on the front chain wheel.

The chain guide may further comprise one or a number of different pieces and types of material such as, but not limited to: a robust synthetic material, metal, plastic or other durable material. It should be noted that, the lower the number of parts, the easier to install and the less susceptible the device will be to breakage or to pieces falling off.

In one advantageous embodiment, the chain guide is assembled onto the bicycle frame via ISCG (International Standard Chain Guide) mounts.

The chain guide device provides a number of advantages including, for example, keeping the chain from falling off the front chain wheel; preventing the chain from sucking up into the bottom of the chain stay; and providing a flat durable surface to land on and perform tricks thereby avoiding damage to the chain and drive mechanism.

In one advantageous embodiment, a bicycle chain guiding device is provided comprising, a first wall having a substantially round perimeter, the first wall having, a shaft opening extending through the first wall for receiving a pedal shaft, and at least one mounting hole extending through the first wall for affixing the first wall to a frame of a bicycle. The device further comprises, a second wall, perpendicular to and positioned about the perimeter of the first wall, the second wall having, an entry opening for permitting a bicycle chain to enter the bicycle chain guiding device, and an exit opening for permitting the bicycle chain to exit the bicycle chain guiding device. The device is provided such that the second wall presents a tapered end at the entry opening to facilitate entry of the chain from multiple angles.

In another advantageous embodiment, a method for guiding a bicycle chain is provided comprising the steps of affixing a first wall having a substantially round perimeter to a bicycle frame, positioning a shaft opening extending through the first wall for receiving a pedal shaft, and positioning at least one mounting hole extending through the first wall for affixing the first wall to the bicycle frame. The method further comprises the steps of affixing a second wall perpendicular to and positioned about the perimeter of the first wall to at least partially define an interior cavity, and positioning an entry opening in the second wall for permitting a bicycle chain to enter the interior cavity. The method still further comprises the steps of tapering an end of the second wall partially defining the entry opening to facilitate entry of the chain to the interior cavity at multiple angles, and positioning an exit opening in the second wall for permitting a bicycle chain to exit the interior cavity.

Other objects of the invention and its particular features and advantages will become more apparent from consideration of the following drawings and accompanying detailed description.

### BRIEF DESCRIPTION OF THE DRAWINGS

FIG. 1 is a front view of the chain guiding device according to one advantageous embodiment.

FIG. 2 is a cross-sectional view along section line XX according to FIG. 1.

FIG. 3 is a rear view of the chain guiding device according to FIG. 1.

FIG. 4 is a cross-sectional view along section line ZZ according to FIG. 3.

FIG. 5 is a view of the chain guiding device according to FIG. 1, mounted to a bicycle frame.

### DETAILED DESCRIPTION OF THE INVENTION

Referring now to the drawings, wherein like reference numerals designate corresponding structure throughout the views.

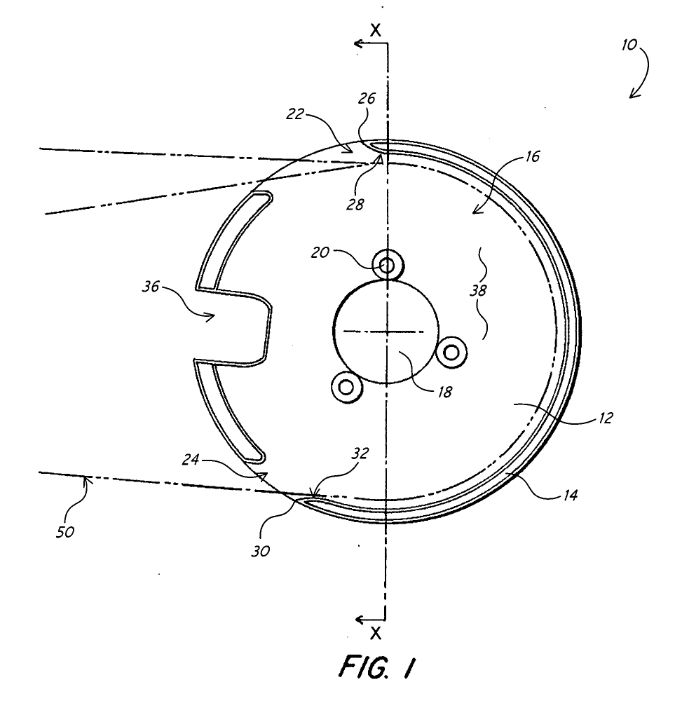

FIG. 1 is a front view of chain guiding device 10 according to one advantageous embodiment. Chain guiding device 10 generally comprises first wall 12 and second wall 14. First wall 12 is provided in this embodiment, having a generally circular shape. Second wall 14 is positioned perpendicular to and along the perimeter of first wall 14, and at least partially defines an interior cavity 16 of chain guiding device 10.

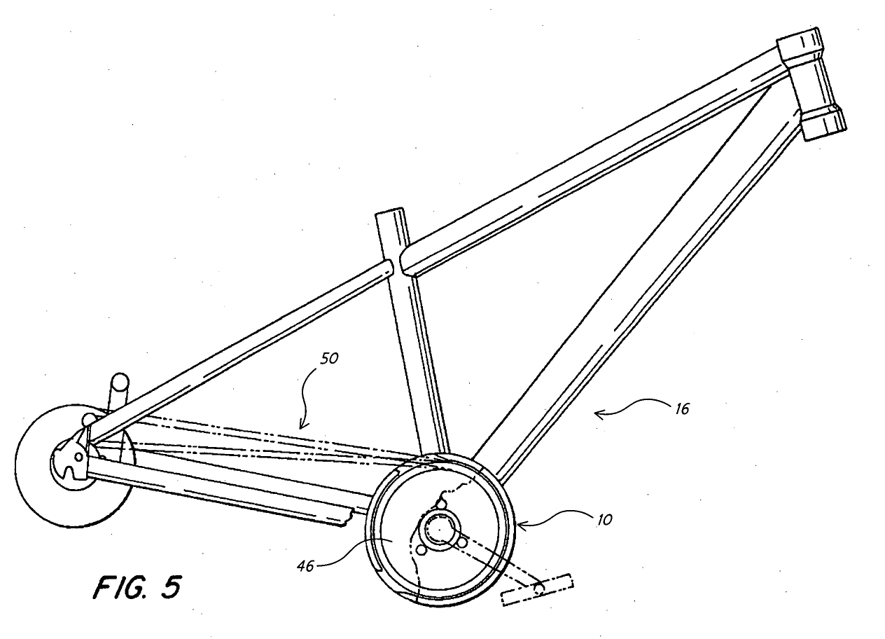

First wall 12 is provided with a shaft opening 18, located in the center of first wall 12 to allow a pedal shaft (not shown) to extend therethrough. Also provided in first wall 12 are mounting holes 20, in this embodiment, three are illustrated. Mounting holes 20 are provided such that chain guiding device 10 may be affixed to the bicycle frame 100 (see FIG. 5). In one advantageous embodiment, the chain guiding device 10 is assembled onto the bicycle frame via ISCG (International Standard Chain Guide) mounts.

Still further illustrated are entry opening 22 and exit opening 24, located in second wall 14. Entry opening 22 and exit opening 24 are provided such that bicycle chain 50 may enter chain guiding device 10 to engage with a front chain wheel (not shown), and then exit the chain guiding device to engage with a rear chain wheel (not shown).

Entry opening 22 in this particular embodiment, is illustrated comprising a larger opening for chain 50 than exit opening 24. In this advantageous embodiment, chain 50 may therefore enter chain guiding device 10 at multiple angles depending upon the application.

To further facilitate chain angle entry, an end portion 26 of first wall 12 that partially defines entry opening 22 is provided as a tapered surface 28. Additionally, end portion 30 of first wall 12 that partially defines exit opening 24 is provided as a tapered surface 32.

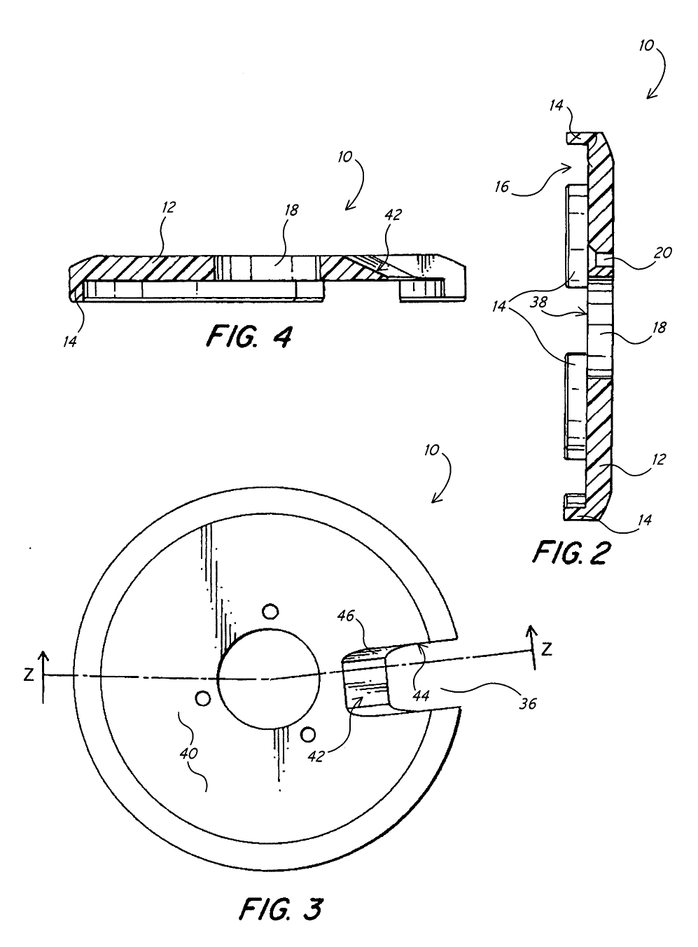

Also illustrated in FIG. 2 is notched opening 34, which is provided to allow chain guiding device 10 to be mounted in close tolerance with the bicycle frame 100 (see FIG. 5). Notched opening 34 extends through both first wall 12 and second wall 14.

It is contemplated that chain guide 10 may comprise one or a number of different pieces and types of material such as, but not limited to: a robust synthetic material, metal, plastic or other durable material. For example, first wall 12 and second wall 14 may be provided as a single molded piece or may be provided as separate pieces.

Turning now to FIG. 2, a cross-section of chain guiding device 10 is illustrated along section line XX (FIG. 1). It can be seen that mounting holes 20 are provided with a tapered portion and a non-tapered portion, allowing a bolt or screw (not shown) to be inserted therein and lay substantially flush with a front surface 38 of first wall 12.

Referring now to FIG. 3, the rear side of chain guiding device 10 is illustrated having a rear surface 40 that is mounted against the bicycle frame 100 (see FIG. 5).

As can be see in FIG. 3, notched opening 36 is provided with a tapered surface 42 such that notched opening 36 extends further into rear surface 40 than into front surface 38. Side walls 44 that partially define notched opening 36 may further be provided as tapered edge portions 46.

FIG. 4 further shows a cross-sectional view of chain guiding device 10 along section line ZZ (FIG. 3) where tapered surface 42 can be seen.

FIG. 5 illustrated chain guiding device 10 affixed to bicycle frame 100. As seen, chain 50 may be alternately attached to various sized rear chain wheels allowing for various angles of entry into chain guiding device 10.

Also provided over chain guiding device 10 is bash guard 46, which is provided to substantially prevent chain 50 from falling to the outside of the bicycle, while the chain guiding device 10 may be used to maintain chain 50 at all points when on the front chain wheel (not shown).

The chain guiding device therefore, provides a number of distinct advantages including, maintaining chain 50 on the front chain wheel due at least in part to the relatively close tolerances of chain 50 with first and second walls 12, 14. Chain guiding device 10 also provides a relatively flat durable surface to land on and perform tricks, which will help prevent any damage from occurring to chain 50 and the chain driving mechanism.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A bicycle chain guiding device comprising:
a first wall having a substantially round perimeter, said first wall having:
a shaft opening extending through said first wall for receiving a pedal shaft;
at least one mounting hole extending through said first wall for affixing said first wall to a frame of a bicycle;
a second wall, perpendicular to and positioned about the perimeter of said first wall, said second wall having:
an entry opening for permitting a bicycle chain to enter said bicycle chain guiding device;
an exit opening for permitting the bicycle chain to exit said bicycle chain guiding device; and
said second wall presenting a tapered end at said entry opening to facilitate entry of the chain from multiple angles.

2. The bicycle chain guiding device of claim 1 wherein said second wall presents a tapered end at said exit opening to facilitate exit of the chain at multiple angles.

3. The bicycle chain guiding device of claim 1 wherein said entry opening is larger than said exit opening.

4. The bicycle chain guiding device of claim 1 wherein said first wall comprises at least three mounting holes extending through said first wall for affixing said first wall to the bicycle frame.

5. The bicycle chain guiding device of claim 1 wherein said first wall further comprises a notched opening therein for flush mounting of said bicycle chain guiding device to the bicycle frame.

6. The bicycle chain guiding device of claim 5 wherein said second wall further comprises an opening therein for flush mounting of said bicycle chain guiding device to the bicycle frame.

7. The bicycle chain guiding device of claim 6 wherein said notched opening comprises a tapered surface such that said notched opening is larger on a rear surface of said first wall than on a front surface of said first wall.

8. The bicycle chain guiding device of claim 1 wherein said bicycle chain guiding device comprises a material selected from the group consisting of: a synthetic material, metal, plastic and combinations thereof.

9. The bicycle chain guiding device of claim 1 further comprising a bash guard mounted to a bicycle crank to substantially enclose an interior cavity at least partially defined by said first and second walls.

10. The bicycle chain guiding device of claim 9 wherein said bash guard comprises the same material as said bicycle chain guiding device.

11. A method for guiding a bicycle chain comprising the steps of:
affixing a first wall having a substantially round perimeter to a bicycle frame;
positioning a shaft opening extending through the first wall for receiving a pedal shaft;
positioning at least one mounting hole extending through the first wall for affixing the first wall to the bicycle frame;
affixing a second wall perpendicular to and positioned about the perimeter of the first wall to at least partially define an interior cavity;
positioning an entry opening in the second wall for permitting a bicycle chain to enter the interior cavity;
tapering an end of the second wall partially defining the entry opening to facilitate entry of the chain to the interior cavity at multiple angles; and
positioning an exit opening in the second wall for permitting a bicycle chain to exit the interior cavity.

12. The method of claim 11 further comprising the step of tapering an end of the second wall partially defining the exit opening to facilitate exit of the chain from the interior cavity at multiple angles

13. The method of claim 11 wherein the entry opening is larger than the exit opening.

14. The method of claim 11 further comprising the step of positioning a notched opening in the first wall for flush mounting of the first wall to the bicycle frame.

15. The method of claim 14 wherein the notched opening comprises a tapered surface such that the notched opening is larger on a back side of the first wall than on a front side of the first wall.

16. The method of claim 11 further comprising the step of positioning a bash guard to a bicycle crank to substantially enclose the interior cavity.
